(19) United States
(12) Patent Application Publication
(10) Pub. No.: US 2018/0168114 A1
(43) Pub. Date: Jun. 21, 2018

(54) Variable Height Trellis

(71) Applicant: Larry McMurray, Hugo, MN (US)

(72) Inventor: Larry McMurray, Hugo, MN (US)

(21) Appl. No.: 15/711,211

(22) Filed: Sep. 21, 2017

Related U.S. Application Data
(60) Provisional application No. 62/397,614, filed on Sep. 21, 2016.

(51) Int. Cl. A01G 17/06; A01G 9/02; A01G 9/12

(52) U.S. Cl. CPC A01G 17/06; A01G 9/12; A01G 9/024

(57) ABSTRACT

This invention relates to a variable height trellis system to be used with a basket that includes multiple strands that are flexible with means to engage climbing plants and vines, to allow the climbing plants and vines to grow along the trellis, thereby creating attractive plant creations.

This application claims the filing date of and relates to the provisional application by the same inventor, Ser. No. 62/397614 filed on Sep. 21, 2016.

### SUMMARY OF INVENTION

This invention relates to a variable height trellis system to be used with a basket that includes multiple strands that are flexible with means to engage climbing plants and vines, to allow the climbing plants and vines to grow along the trellis, thereby creating attractive plant creations.

### DETAILED DESCRIPTION OF DRAWINGS

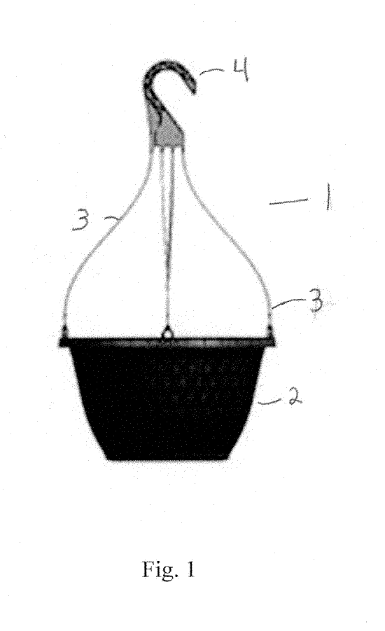

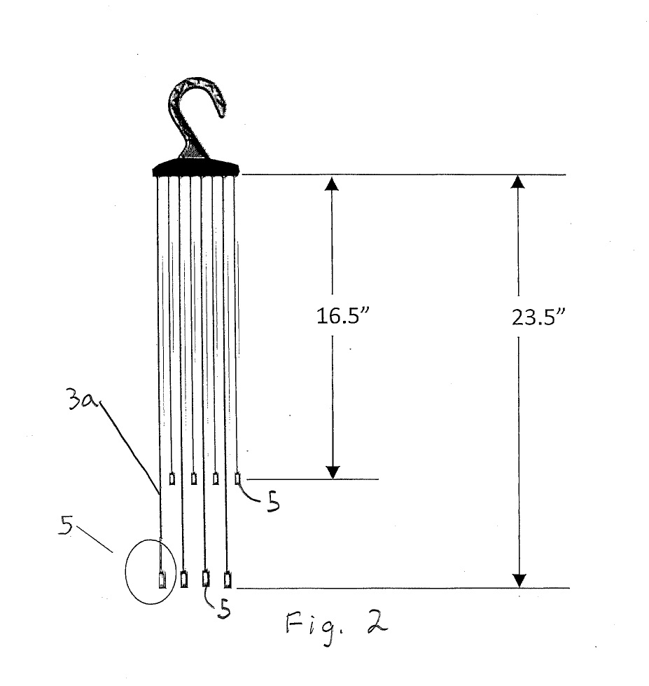

A variable height trellis as shown in the FIG. 1 is disclosed.

FIG. 1 shows a view of the variable height trellis 1 alone and with a hanging basket 2. The average four strand portion 3, would attach to the hanging basket 2 equidistant around the open diameter of the basket, for a twenty-two inch tall basket, although another embodiment could include three or more strands for smaller and larger hanging baskets. A hook 4 is shown attached to the strand portion 3 for hanging the variable heights trellis system and hanging basket. It can also be utilized as a container trellis and fabricated without the hook 4 at the top.

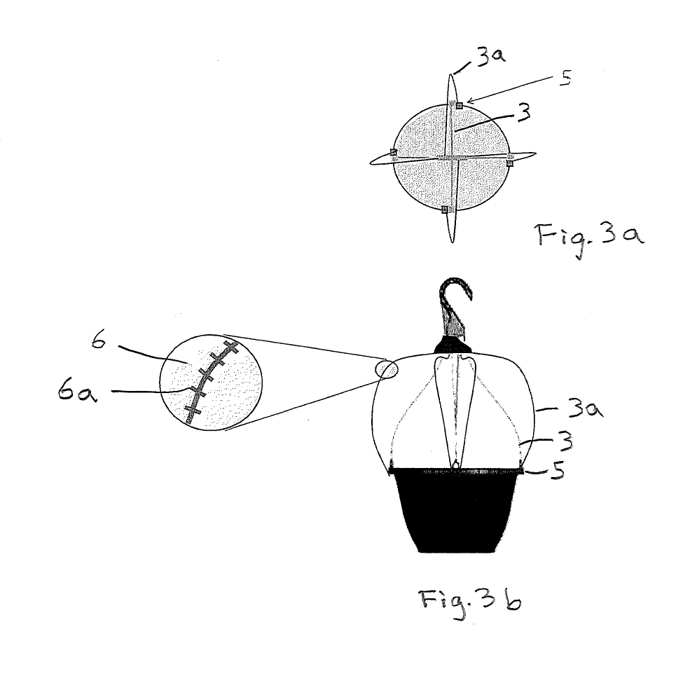

FIG. 2 shows additional longer strands 3a that can be placed between the average length strands. Each strand 3 and 3a has detachable means 5 to snap on the rim of a container or on an adjustable belt.

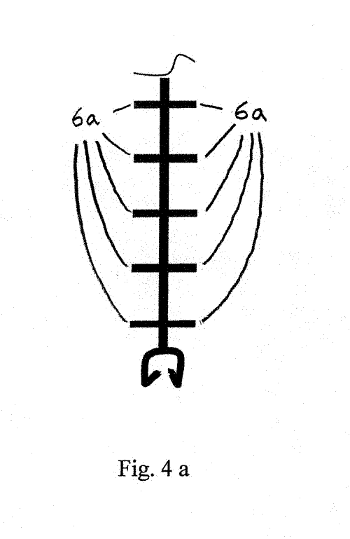

FIG. 3a is a top view shows both long strands 3a and short strands 3 clipped next to each other.

FIG. 3b is a side view showing the short strands 3 and the long Strands 3a clipped together by the clip 5. The strands 3 and 3a have a plant engaging means 6 in the form of a cross knob 6a.

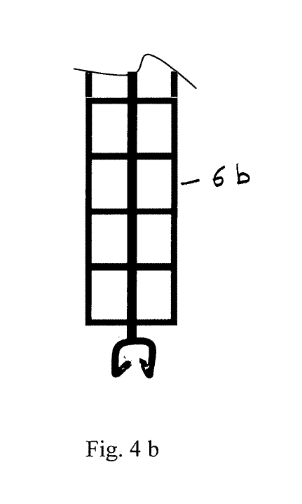

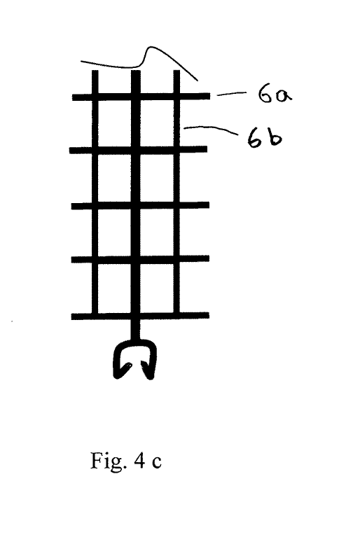

Referring now to FIGS. 4a, 4b and 4c, other engaging means 6 are shown. The cross knob 6a is shown in FIG. 4a FIG. 4b shows a closed box engaging means 6b, and FIG. 4c shows a combination of the cross knob 6a and closed box 6b engaging means. The engaging means 6 allow the climbing plants and vines to attach to the trellis and also prevent vines from sliding down the strands. The closed boxes 6b allow for plants that vine to pass through the closed box 6b to allow the vine's leaves to open after passing through the closed box 6b.

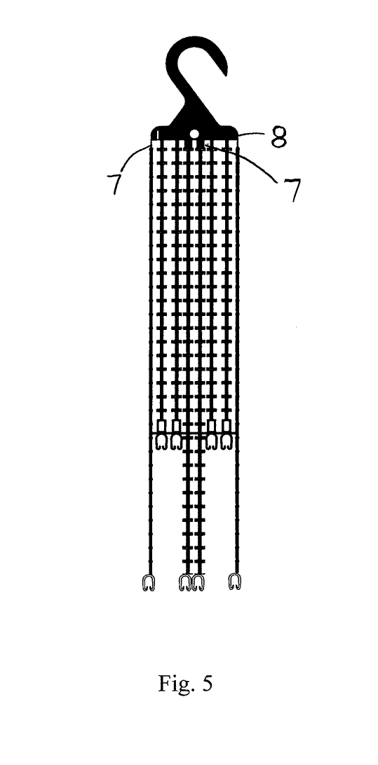

FIG. 5 shows an exploded-type view of the strands 3 and 3a, with a flat section 7, on the longer strands to enable a bending point (hinge) in the desired fold direction. The flat section 7 shown on the longer strands allows the initiation of a fold outward. A shoulder 8 of the hook 4 hanger is where the strands 3 and 3a attach to the hook 4.

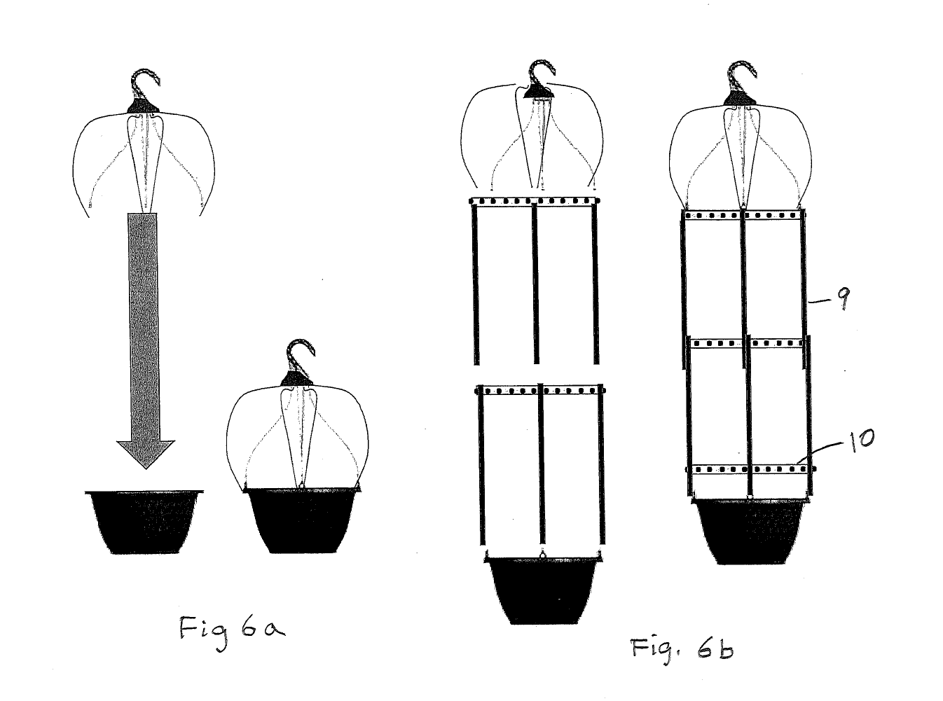

FIG. 6a shows the strands 3 and 3a attached directly to a basket or container.

FIG. 6b shows another embodiment with extension pieces 9 that creates a longer hanging basket assembly, allowing longer climbing plants and vines. Belts 10 hold the extension pieces 9 in proper formation.

I claim:

1. A variable height trellis comprising a plurality of strands, each strand comprising a length, an engaging means, a clip end and a hook end, the clip end comprising a detachable clip to attach the strand to a container and the hook end flexibly attached to a hook.

2. The variable height trellis of claim 1 wherein the engaging means is a series of cross knobs.

3. The variable height trellis of claim 1 wherein the engaging means is a closed box engaging means.

4. The variable height trellis of claim 1 wherein the engaging means is a combination of cross knobs and closed box engaging means.

5. The variable height trellis of claim 1 wherein the strands have various lengths.

6. The variable height trellis of claim 1 further comprising plurality of extension pieces and at least one belt, wherein each extension piece is attached to the clip end of the strand and to the container, and the belt is detachably attached to the extension pieces forming a circumference around the extension pieces.

7. The variable height trellis of claim 6 wherein the extension pieces further comprise the cross knob engaging means.
